(19) United States
(12) Patent Application Publication
(10) Pub. No.: US 2015/0235797 A1
(43) Pub. Date: Aug. 20, 2015

(54) FUSE

(71) Applicant: YAZAKI CORPORATION, Tokyo (JP)

(72) Inventor: Masashi IWATA, Susono-shi (JP)

(73) Assignee: YAZAKI CORPORATION, Tokyo (JP)

(21) Appl. No.: 14/625,060

(22) Filed: Feb. 18, 2015

(30) Foreign Application Priority Data
Feb. 20, 2014 (JP) 2014-030841

(51) Int. Cl. H01H 85/055

(52) U.S. Cl. CPC H01H 85/055

(57) ABSTRACT

There is provided a fuse including a pair of terminals and a fusible part formed between the pair of terminals to make conductive connection between the pair of terminals. The fusible part including a fusing-set part fused when an overcurrent flows. A low-melting-point metal layer is formed on the fusing-set part of the fusible part by a solid modeling method.

### CROSS REFERENCE TO RELATED APPLICATIONS

This application is based upon and claims the benefit of priority of Japanese Patent Application No. 2014-030841 filed on Feb. 20, 2014, the contents of which are incorporated herein by reference in its entirety.

### BACKGROUND OF THE INVENTION

1. Field of the Invention

The present invention relates to a fuse for breaking energization by being fused at the time when an overcurrent flows, and particularly to a fuse in which a fusing-set part is provided with a low-melting-point metal.

2. Description of the Related Art

FIG. 4 is a plan view showing a configuration of a fuse described in JP-A-2009-289513. A fuse 101 shown in FIG. 4 includes a pair of terminals 102, 103 conductively connected through a fusible part 110, and a chip-shaped low-melting-point metal 120 fastened to a fusing-set part 111 on the fusible part 110 by crimping using a crimp piece 112. The fusible part 110 is the portion which makes conductive connection between the terminals 102, 103 and is fused at the time when an overcurrent flows. The low-melting-point metal 120 is melted by a rise in temperature of the fusible part 110 by energization and is spread in the fusing-set part 111 to form an alloy layer and facilitates fusing.

### SUMMARY OF THE INVENTION

In the case of mounting the low-melting-point metal 120 on the fusible part 110, it is very important but difficult to manage a position or the amount of the low-melting-point metal 120. When the chip-shaped low-melting-point metal 120 is fastened using the crimp piece 112 conventionally, the amount of the low-melting-point metal 120 tends to vary or the area of contact between the low-melting-point metal 120 and the fusible part 110 tends to vary. As shown in FIG. 5, an increase in such variations also increases variations in fusing characteristics. In the worst case, an out-of-specification product in which fusing specifications are not satisfied may be generated. In such a case, there is fear that wire smoke-producing protection is insufficient.

Hence, a non-limited object of the present invention is to solve the problem described above, and is to provide a fuse capable of accurately managing an area of contact with a base material or the amount in the case of mounting a low-melting-point metal on a fusing-scheduled part.

The above object of the present invention may be achieved by the following exemplified configurations.

(1) A fuse including:

a pair of terminals;

a fusible part formed between the pair of terminals to make conductive connection between the pair of terminals, the fusible part including a fusing-set part fused when an overcurrent flows; and

a low-melting-point metal layer formed on the fusing-set part of the fusible part by a solid modeling method.

(2) The fuse according to the configuration (1), wherein the low-melting-point metal layer is formed on an upper surface of the fusing-set part.

(3) The fuse according to the configuration (1), wherein the low-melting-point metal layer is formed on a whole peripheral surface of the fusing-set part.

(4) The fuse according to the configuration (i), wherein the low-melting-point metal layer is integrated with the fusing-set part.

According to the fuse with the configuration (1), (2) or (4), the low-melting-point metal layer is formed by the solid modeling method, with the result that the area of contact with a base material (fusible part) and the amount of low-melting-point metal can easily be kept within a prescribed design scope. In other words, variations in the contact area or the amount of low-melting-point metal can be reduced. Consequently, variations in fusing characteristics of the fuse can be reduced to obtain intended design fusing characteristics, and smoke production of an electric wire can be prevented surely.

According to the fuse with the configuration (3), the low-melting-point metal layer is formed on the whole peripheral surface of the fusing-set part, with the result that spreading of the low-melting-point metal to the fusing-set part can be facilitated.

According to the exemplified configurations of the present invention, the low-melting-point metal layer is formed by the solid modeling method, with the result that the area of contact with the fusible part (base material) or the amount of low-melting-point metal can be managed with high accuracy.

The present invention has briefly been described above. Further, the details of the present invention will become more apparent by reading through a mode (hereinafter called an “embodiment”) for carrying out the present invention described below with reference to the accompanying drawings.

### BRIEF DESCRIPTION OF THE DRAWINGS

In the accompanying drawings:

FIG. 1A is a perspective view mainly showing a fusible part in a fuse according to a first embodiment of the present invention;

FIG. 1B is a plan view of the fusible part;

FIG. 1C is a side view of the fusible part;

FIG. 2A is a sectional view showing a case of forming a low-melting-point metal layer on an upper surface of a fusing-set part;

FIG. 2B is a sectional view showing a case of forming a low-melting-point metal layer on a peripheral surface of the fusing-set part;

FIG. 3 is a characteristic diagram of the fuse of FIG. 1;

FIG. 4 is a perspective view showing one example of a conventional fuse; and

FIG. 5 is a characteristic diagram of the conventional fuse.

### DETAILED DESCRIPTION OF THE EXEMPLARY EMBODIMENTS

An embodiment of the present invention will hereinafter be described with reference to the drawings.

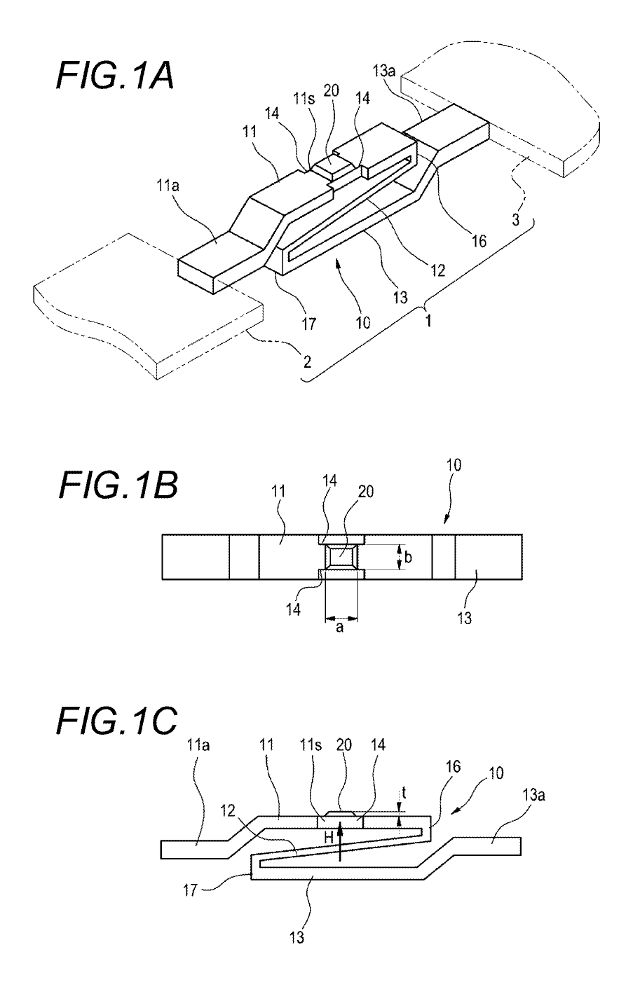

FIG. 1A is a perspective view mainly showing a fusible part in a fuse according to the embodiment, FIG. 1B is a plan view of the fusible part, and FIG. 1C is a side view of the fusible part.

As shown in FIGS. 1A to 1C, a fuse 1 according the embodiment has a pair of flat plate-shaped terminals 2, 3 on both ends, and has a fusible part 10 formed between the pair of terminals 2, 3, which makes conductive connection between both of the terminals 2, 3 and is fused at the time when an overcurrent flows. A predetermined part (a fusing-set part 11s described below) of the fusible part 10 is provided with a low-melting-point metal layer 20.

Here, a metal conductor constructing the terminals 2, 3 and the fusible part 10 is made of a copper alloy. On the other hand, the low-melting-point metal layer 20 is made of a tin alloy or tin (Sn) with a melting point lower than that of copper (Cu), and is configured to be melted by a rise in temperature by energization and be spread in the fusing-set part and form an alloy layer.

The fusible part 10 is formed in a folded shape with substantially a Z shape in side view in which a first strip plate piece 11 of the uppermost side, a second strip plate piece 12 of its lower side and a third strip plate piece 13 of the lowermost side are formed continuously. Concretely, the second strip plate piece 12 continues with the distal end of the first strip plate piece 11 through a bent part 16 bent in a U shape in a thickness direction, and the third strip plate piece 13 continues with the distal end of the second strip plate piece 12 through a bent part 17 bent in a U shape in the thickness direction.

The second strip plate piece 12 is positioned just over the third strip plate piece 13 at a short distance, and the first strip plate piece 11 is positioned just over the second strip plate piece 12 at a short distance. Also, the proximal end 11a of the first strip plate piece 11 and the proximal end 13a of the third strip plate piece 13 are set in the same height, and are connected to the terminals 2, 3, respectively.

An intermediate part of the first strip plate piece 11 of the uppermost side in a length direction is provided with the fusing-set part 11s melted and broken by a rise in temperature by an overcurrent. The fusing-set part 11s is the portion set so as to be instantaneously fused at the time when a large current flows by locally making the cross-sectional area smaller than that of the other portion by putting notches 14 in both side edges in a width direction.

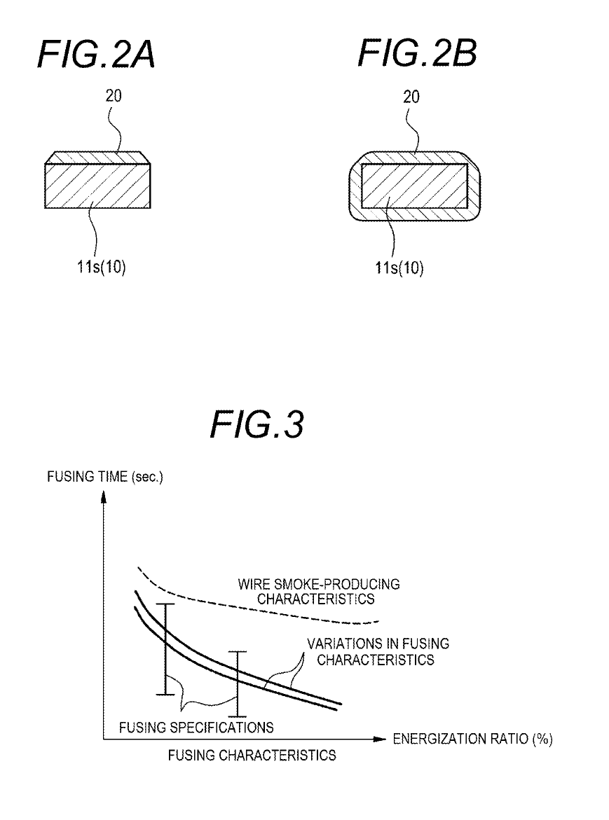

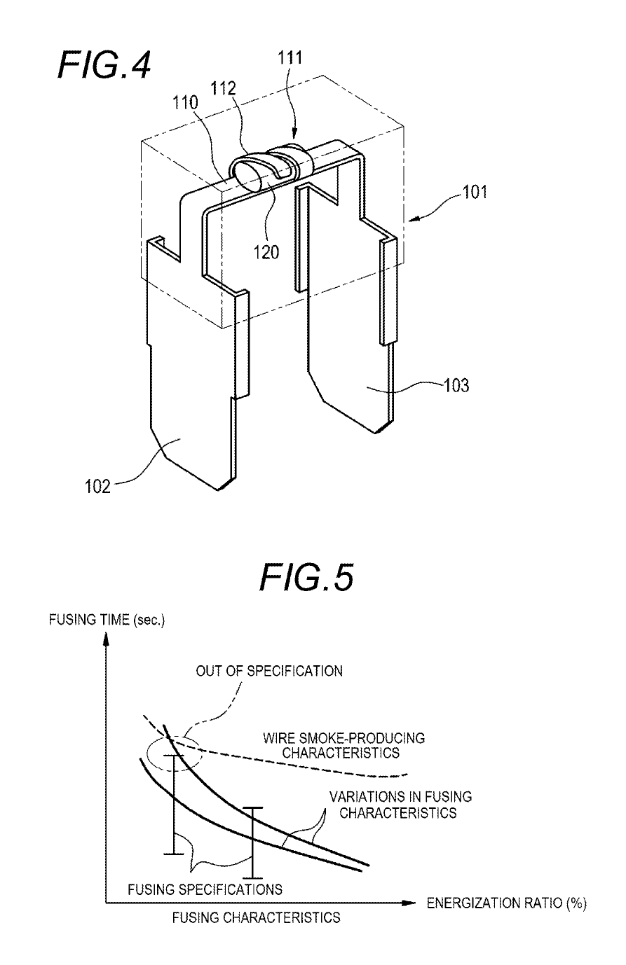

The low-melting-point metal layer 20 has a melting point lower than that of a fusible metal conductor constructing the fusible part 10, and is melted by an overcurrent and is spread in the fusing-set part 11s to form an alloy layer, and is formed on the fusing-set part 11s. In addition, the low-melting-point metal layer 20 may be formed on only an upper surface of the fusing-set part 11s as shown in FIG. 2A, or formed on only a lower surface, both of the upper surface and the lower surface, or one or both of side surfaces of the fusing-set part 11s. Alternatively, the low-melting-point metal layer 20 may be formed on the whole peripheral surface of the fusing-set part 11s in a cross section as shown in FIG. 2B.

Both of the terminals 2, 3 in elements constructing the fuse 1 are formed by punching a metal flat plate material by a pressing work. On the other hand, the fusible part 10 is formed by a solid modeling method (three-dimensional modeling method by the so-called 3D printer) rather than press molding. The fusible part 10 is constructed of a powder sintered body made of a copper alloy such as NB105. Also, the low-melting-point metal layer 20 is formed by the solid modeling method (three-dimensional modeling method by the so-called 3D printer) using tin powder or tin alloy powder as a material.

Connection between the terminals 2, 3 and the fusible part 10 can also be made using welding unit or the like after the fusible part 10 is formed by the solid modeling method, but the connection is made by the solid modeling method itself since the solid modeling method is adopted for forming of the fusible part 10 herein. In other words, the terminals 2, 3 are previously held in a modeling space in which the solid modeling method is performed, and the fusible part 10 is formed in the form of integrating the fusible part 10 with the terminals 2, 3 by the solid modeling method. Accordingly, a product in which the terminals 2, 3 are coupled to the fusible part 10 formed can be obtained.

In the low-melting-point metal layer 20, after forming of the fusible part 10, the formed fusible part 10 is held in modeling space and then, the low-melting-point metal layer 20 can be formed in the form of being integrated with the fusible part 10 by the solid modeling method. Also, it is contemplated to simultaneously manufacture the low-melting-point metal layer 20 and the fusible part 10 made of different kinds of metals by the solid modeling method.

The solid modeling method is a technique for modeling a three-dimensional product shape by slicing three-dimensional shape data of a product into thin layers on a calculator and calculating cross-sectional shape data of each of the sliced layers and sequentially forming thin layers physically by the calculated data and laminating and coupling the thin layers.

The solid modeling method includes a fused deposition modeling method, an optical modeling method, a powder sintering method, an ink-jet method, a projection method, an ink-jet powder lamination method, etc., and since a material is a metal herein, the powder sintering method or the ink-jet powder lamination method is effective.

For example, the powder sintering method performs modeling in the following order.

(1) First, material powder is thinly laid on a bed for modeling.

(2) Next, a cross-sectional shape of the lowermost layer of cross-sectional shapes is drawn by, for example, a laser, an electron beam or ultraviolet rays, and powder of the drawn portion is sintered.

(3) After a cross section of the lowermost layer is sintered, the bed is downwardly moved by height equal to a slice distance, and the material powder is laid on the bed in thinness equal to the slice distance.

(4) Then, a cross-sectional shape of a layer upper than the previously formed cross section by one is again drawn by a laser, and powder of the drawn portion is sintered.

(5) A solid is modeled by repeating the above steps.

In the ink-jet powder lamination method, material powder is discharged just like an ink-jet printer, and for example, a laser, ultraviolet rays or heat is applied to the material powder to sinter the material powder, and while sequentially repeating sintering and lamination of thin layers, an integral solid is modeled.

Since at least the low-melting-point metal layer 20 is formed on the fusing-set part 11s by the solid modeling method in this manner, the area of contact with a base material (fusible part) and the amount of low-melting-point metal can easily be kept within a prescribed design scope. For example, when the area of contact between the low-melting-point metal layer 20 and the base material (fusing-set part 11s) is set at S and the volume (amount) of the low-melting-point metal is set at M and longitudinal and transverse dimensions of the low-melting-point metal layer 20 with a rectangular shape in plan view are set at a, b and the thickness is set at t, the following formulas are obtained.

S=a×b

M=S×t

Since it is easy to manage the values of a, b, t in the case of the solid modeling method, the area of contact with the base material (fusible part) and the amount of low-melting-point metal can be managed with high accuracy. In other words, variations in the contact area and the amount of low-melting-point metal can be reduced, with the result that variations in fusing characteristics of the fuse can be reduced to obtain intended design fusing characteristics kept within fusing specifications, and smoke production of an electric wire can be prevented surely as shown in FIG. 3.

As shown in FIG. 3, the fusing characteristics of the embodiment are kept within the fusing specifications, and have no out-of-specification problem, and are better than fusing characteristics by a conventional configuration shown in FIG. 5.

Also, when the low-melting-point metal layer 20 is formed on the whole peripheral surface of the fusing-set part 11s as shown in the sectional view of FIG. 2B, spreading of the low-melting-point metal to the fusing-set part 11s can be facilitated.

When the low-melting-point metal layer 20 is formed with high accuracy in this manner, a wide contact surface is ensured between the fusible part 10 and the low-melting-point metal layer 20, and a current and heat are effectively transferred to the low-melting-point metal layer 20 through this wide contact surface.

Since the fusible part 10 is formed by the solid modeling method in this embodiment, cross-sectional dimensions, lengths, shapes, etc. of the fusible part 10 can be set freely. For example, thickness, width, length or shape can be set freely. Consequently, by decreasing the cross-sectional dimensions (width or thickness) of the fusible part 10, the whole length of the fusible part 10 can be decreased to thereby miniaturize the fusible part 10 and therefore the fuse 1.

Even when the whole length of the fusible part 10 becomes long, by configuring the fusible part 10 in three dimensions like the embodiment, the shape in plan view can be decreased to thereby contribute to miniaturization of the fusible part 10 and therefore the fuse 1. Particularly in the case of the fuse 1 of the embodiment, the fusible part 10 has the folded shape, with the result that heat of the fusible part (second and third strip plate pieces 12, 13) of the lower side rises upwardly as shown by arrow H in FIG. 1C by an attitude used and thereby, fusing of the fusing-set part 11s of the fusible part (first strip plate piece 11) of the upper side can be facilitated to improve fusing performance.

In addition, in the embodiment, the case of forming the low-melting-point metal layer 20 and the fusible part 10 by the solid modeling method is shown, but the whole fuse 1 including the terminals 2, 3 can also be formed by the solid modeling method.

Also, the present invention is not limited to the embodiment described above, and modifications, improvements, etc. can be made properly Moreover, as long as the present invention can be achieved, materials, shapes, dimensions, the number of components, arrangement places, etc. of each of the components in the embodiment described above are freely selected and are not limited.

For example, in the embodiment described above, the case of forming the fusible part 10 by the solid modeling method is shown, but the fusible part 10 may be formed by methods other than the solid modeling method.

Here, some exemplary aspects of the fuse according to the present invention described above are briefly summarized and listed in the following configurations [1] to [4], respectively.

[1] A fuse (1) including a pair of terminals (2, 3), a fusible part (10) formed between the pair of terminals (2, 3) to make conductive connection between the pair of terminals (2, 3), the fusible part (10) including a fusing-set part (11s) fused when an overcurrent flows, and a low-melting-point metal layer (20) formed on the fusing-set part (11s) of the fusible part (10) by a solid modeling method.

[2] The fuse (1) as described in the configuration [1], wherein the low-melting-point metal layer (20) is formed on an upper surface of the fusing-set part (11s).

[3] The fuse (1) as described in the configuration [1], wherein the low-melting-point metal layer (20) is formed on a whole peripheral surface of the fusing-set part (11s).

[4] The fuse (1) as described in the configuration [1], wherein the low-melting-point metal layer (20) is integrated with the fusing-set part (11s).

What is claimed is:

1. A fuse comprising:
a pair of terminals;
a fusible part formed between the pair of terminals to make conductive connection between the pair of terminals, the fusible part including a fusing-set part fused when an overcurrent flows; and
a low-melting-point metal layer formed on the fusing-set part of the fusible part by a solid modeling method.

2. The fuse according to claim 1, wherein the low-melting-point metal layer is formed on an upper surface of the fusing-set part.

3. The fuse according to claim 1, wherein the low-melting-point metal layer is formed on a whole peripheral surface of the fusing-set part.

4. The fuse according to claim 1, wherein the low-melting-point metal layer is integrated with the fusing-set part.
